(19) United States
(12) Patent Application Publication
(10) Pub. No.: US 2004/0238396 A1
(43) Pub. Date: Dec. 2, 2004

(54) Flower box assembly

(76) Inventors: Johannes Theodorus Maria Slingerland, Voorhout (NL); Antonius Johanna Maria Loverbos, Asten (NL); Hendricus Bernardus Johannes Lamboo, Noordwijk (NL); Bernardus Johannes Leonardus Lamboo, Noordwijk (NL)

Correspondence Address: WEINGARTEN, SCHURGIN, GAGNEBIN & LEBOVICI LLP, TEN POST OFFICE SQUARE, BOSTON, MA, 02109, US

(21) Appl. No.: 10/806,070

(22) Filed: Mar. 22, 2004

(30) Foreign Application Priority Data
Mar. 20, 2003 (NL) 1022981
Sep. 12, 2003 (NL) 1024283

(51) Int. Cl. H02G 3/08

(52) U.S. Cl. 206/503

(57) ABSTRACT

A flower box assembly comprising an inner box and an inner box holder, the inner box having a bottom wall and at least one closed sidewall, such that it is at least partly fillable with water, the inner box holder having at least one sidewall and an open lower side and upper side, the inner box being provided with means with the aid of which the inner box is detachably connectible with the inner box holder, while, preferably, the inner box holder and the inner box are so designed that onto an assembly of an inner box holder and an inner box, a second inner box holder is placeable in inverted position, the downwardly directed upper side of the second inner box holder engaging an upper side of the inner box, or the upper side of the first inner box holder.

The invention relates to a flower box assembly. Such flower box assemblies are intended in particular for use at auctions or the like and serve for the storage and the transport of cut flowers.

The invention provides a flower box assembly comprising an inner box and an inner box holder, the inner box having a bottom wall and at least one closed sidewall, such that it is at least partly fillable with water, the inner box holder having at least one sidewall and an open lower side and upper side, the inner box being provided with means with the aid of which the inner box is detachably connectible with the inner box holder.

Such an assembly which is preferably manufactured entirely from plastic can be made of particularly stable design. Owing to the inner box and the inner box holder being detachably connectible with each other, the inner boxes and the inner box holders can be stored separately from each other, for instance by nested stacking of the inner boxes within each other and nested stacking of the inner box holders within each other.

According to a further elaboration of the invention, the inner box holder and the inner box can be so designed that onto an assembly of an inner box holder and an inner box, a second inner box holder is placeable in inverted position, the downwardly directed upper side of the second inner box engaging an upper side of the inner box, or the upper side of the first inner box holder.

The inner box holder then has a double function. On the one band, the inner box holder can form a stable holder for an inner box, so that falling over of the inner box is prevented by the stable inner box holder. On the other hand, an inner box holder, when placed in inverted position on an assembly of an inner box holder and an inner box, can constitute a protection for the cut flowers projecting above the upper side of the inner box.

To afford a third function to the inner box container, according to a further elaboration of the invention, the inner box holder may be so designed that onto the second inner box holder, a third inner box holder is placeable, with its upper side directed upwards, such that, in turn, an inner box is receivable in it.

The second inner box holder then not only protects the cut flowers projecting above the upper side of the inner box, but additionally serves as a support for a second assembly of an inner box and an inner box holder. Accordingly, in this way, cut flower-filled assemblies of inner boxes with inner box holders can be stacked onto each other. This yields a considerable saving a space. Moreover, it is particularly favorable that this stacking possibility does not require any additional parts. This additional functionality is obtained with the inner box and inner box holder which are necessary anyway.

According to a further elaboration of the invention, it is preferred that the sidewalls of the inner box holders, viewed from the bottom, taper slightly towards each other in the direction of the upper side, such that the inner box holders are mutually nestable. The result is that the inner box holder sits on the ground with a large base and thus provides a stable arrangement. As regards the inner boxes, too, according to a further elaboration, the sidewalls thereof, viewed from an upper side, taper slightly towards each other in the direction of the bottom wall, such that the inner boxes are mutually nestable. Thus, both the inner boxes and the inner box holders can be stored in a nested stack occupying little space.

Further, according to a further elaboration of the invention, it is favorable when in the at least one sidewall of the inner box holders, at least one light passage opening is included. What is accomplished in this way is that the cut flowers in the lower assemblies of a stack of cut flower-filled flower box assemblies are still illuminated and aerated in a natural way

Further elaborations of the invention are described in the subclaims and will be further clarified hereinafter on the basis of a number of exemplary embodiments with reference to the drawing.

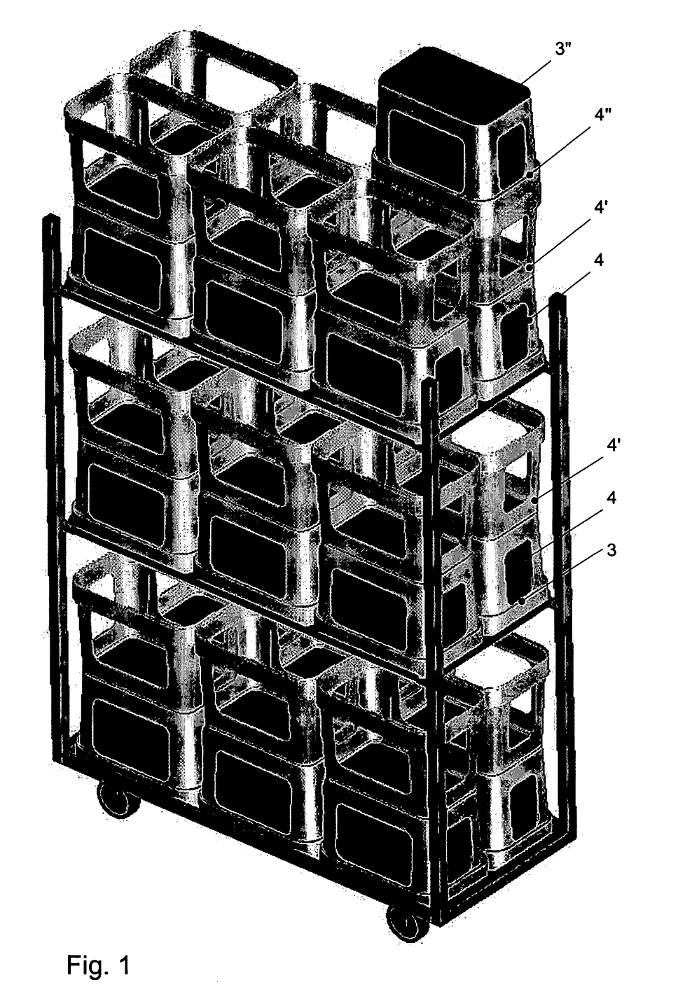

FIG. 1 shows a perspective view of an embodiment of a number of flower box assemblies placed on a dolly;

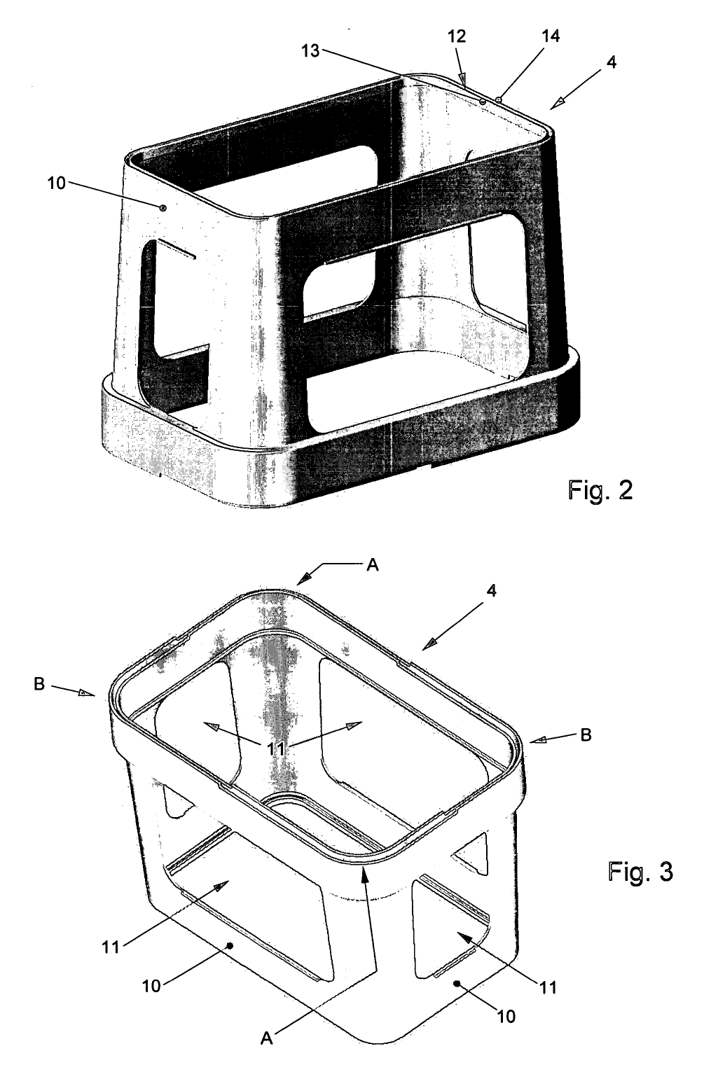

FIG. 2 shows a perspective top plan view of an inner box holder according to a first exemplary embodiment of the invention;

FIG. 3 shows a perspective bottom plan view of the inner box holder shown in FIG. 2;

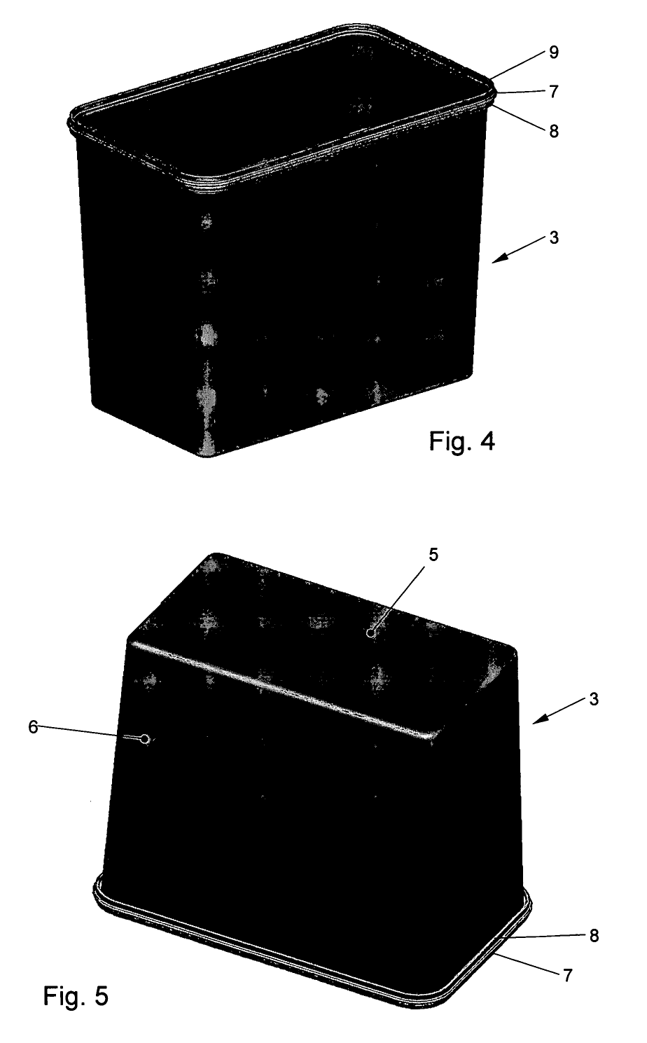

FIG. 4 shows a perspective top plan view of an inner box of the first exemplary embodiment;

FIG. 5 shows a perspective bottom plan view of the inner box shown in FIG. 4;

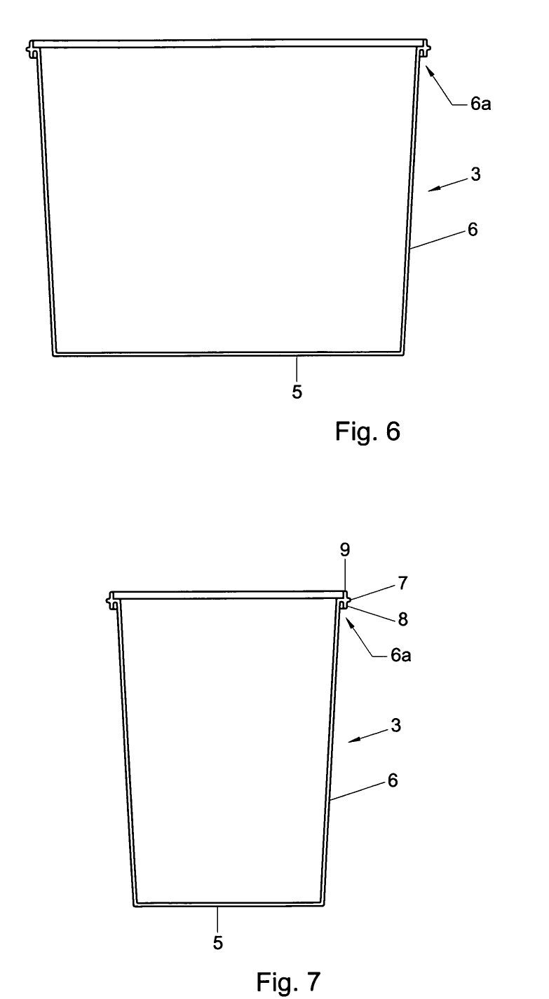

FIG. 6 shows a vertical longitudinal cross section of the inner box shown in FIG. 4;

FIG. 7 shows a vertical transverse cross section of the inner box shown in FIG. 4;

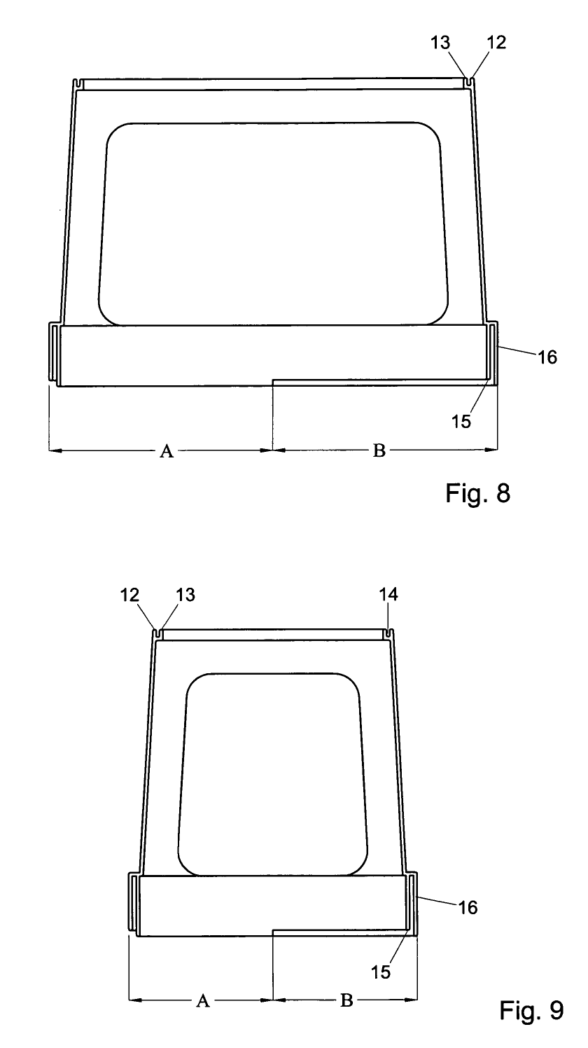

FIG. 8 shows a vertical longitudinal cross section of the inner box holder shown in FIG. 2;

FIG. 9 shows a vertical transverse cross section of the inner box holder shown in FIG. 2;

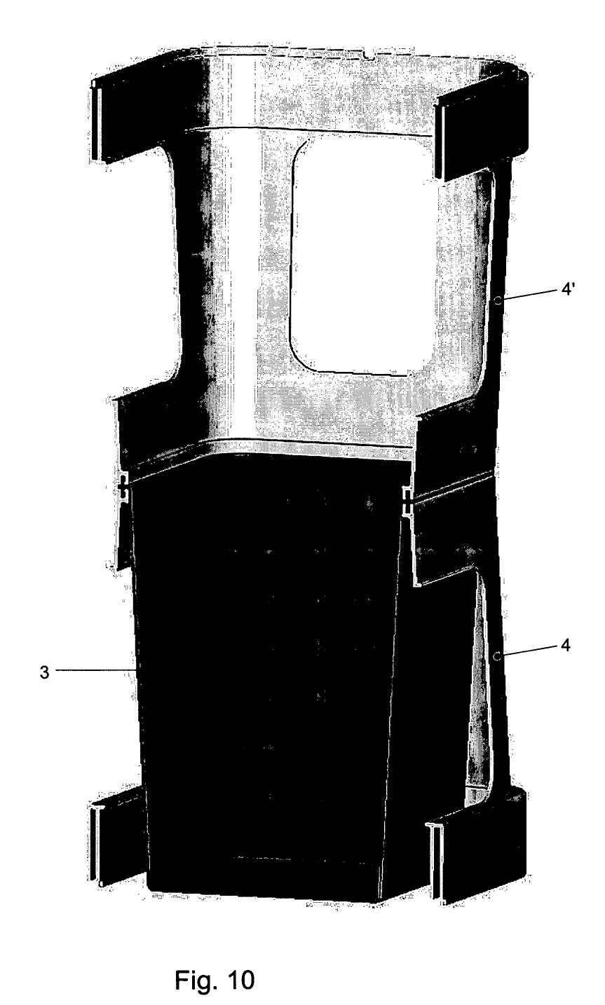

FIG. 10 shows a perspective, partly cutaway view of an assembly of an inner box and an inner box holder of the first exemplary embodiment with a second inner box holder placed thereon in inverted position;

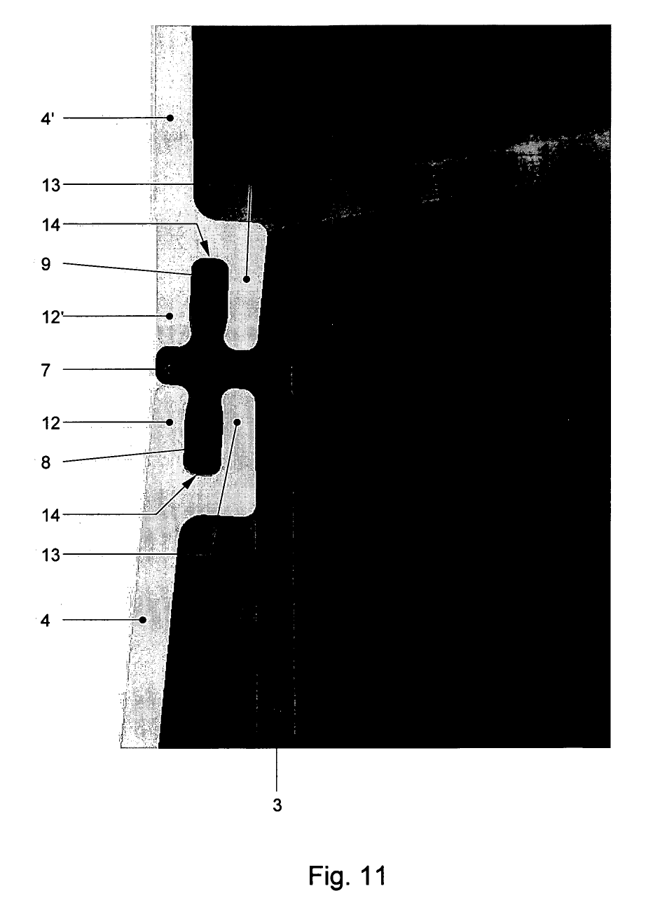

FIG. 11 shows, in cross section, in more detail, the manner in which the inner box of the first exemplary embodiment is connected with the first and the second inner box holder;

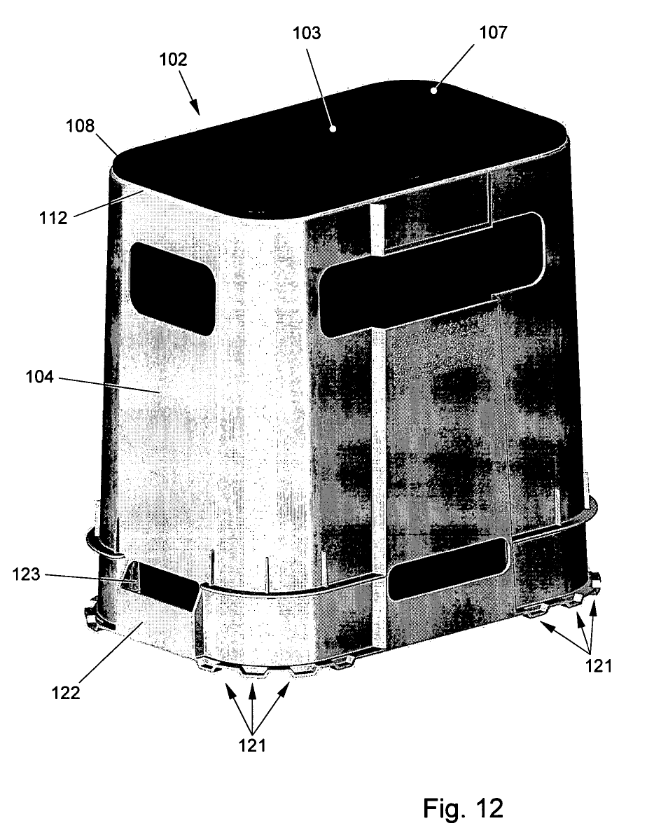

FIG. 12 shows a perspective top plan view of a second exemplary embodiment of the invention, with the inner box holder in a first position;

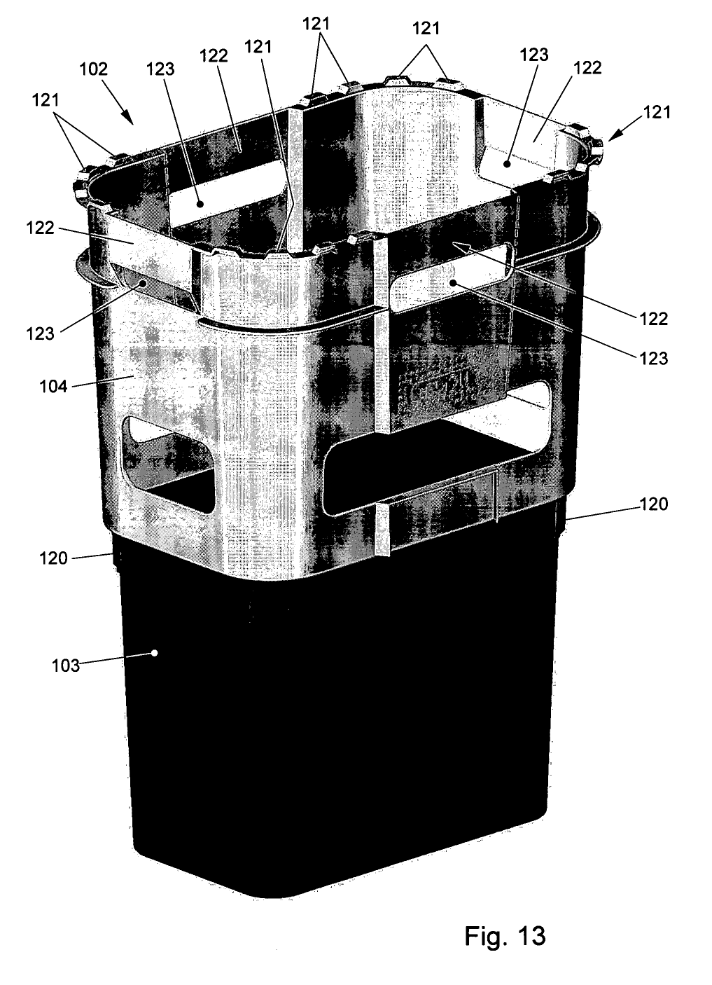

FIG. 13 shows a similar top plan view to FIG. 12, with the inner box holder in an inverted, second position;

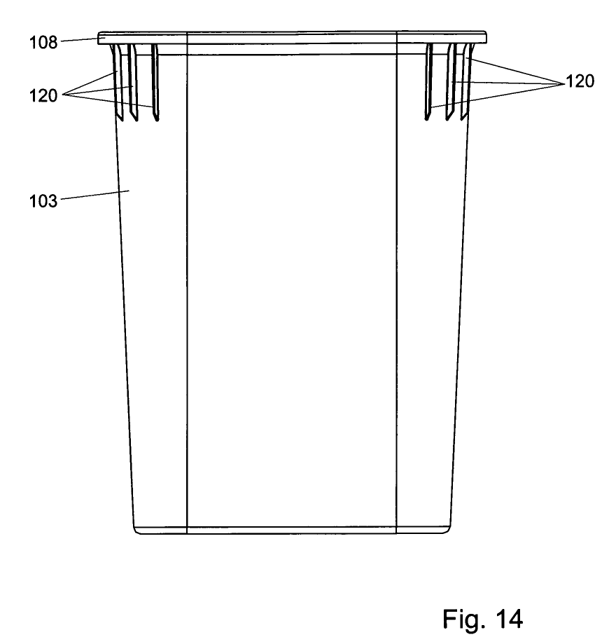

FIG. 14 shows a front view of the inner box of the exemplary embodiment represented in FIG. 12;

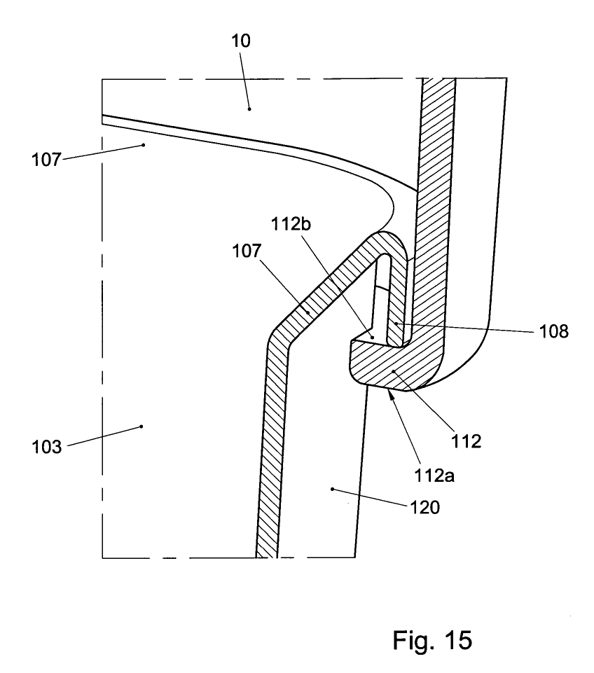

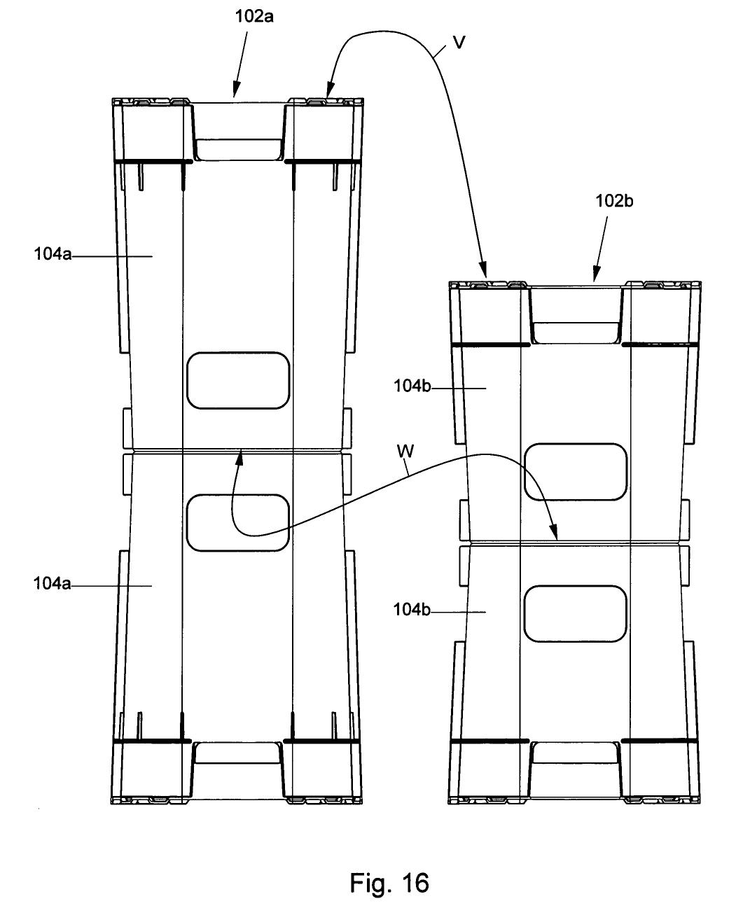

FIG. 15 shows, in cross section, in more detail, the manner in which the inner box of the exemplary embodiment represented in FIG. 13 is coupled to the inner box holder; and

FIG. 16 shows a front view of a high and a low design of an assembly according to the invention.

FIG. 1 shows a so-called Danish dolly 1 on which a number of flower box assemblies 2 according to the invention are depicted. A flower box assembly according to a first exemplary embodiment comprises an inner box 3, which is represented in detail in FIGS. 4, 5, 6, and 7, and an inner box holder 4, which is represented in detail in FIGS. 2, 3, 8, and 9.

The inner box 3 of the first exemplary embodiment has a bottom wall 5 and four closed sidewalls 6, such that the inner box can be filled at least partly with water. Adjacent the upper side of the sidewalls 6, means are provided with the aid of which the inner box 3 is connectible with the inner box holder 4. These means comprise a circumferential wall 7 extending in a substantially horizontal direction, which is connected with the inner box 3 adjacent an upper edge 6a of the sidewalls of the inner box 3. The circumferential wall 7 is provided with at least one first projection 8. The projection 8 comprises a wall part extending throughout the circumference of the inner box, from the circumferential wall 7 in downward direction. The circumferential wall 7 is further provided with at least one second projection 9, which extends in upward direction from the circumferential wall 7 and which is situated opposite the first projection 8. This second projection 9 also extends throughout the circumference of the inner box 3. Viewed from an upper side, the sidewalls 6 of the inner boxes 3 taper slightly in the direction of the bottom wall 5, so that loose inner boxes 3 are mutually nestable.

In the first exemplary embodiment, the inner box holder 4 is provided with four sidewalls 10. Further, the inner box holder 4 has an open lower and upper side. The sidewalls of the inner box holder 4, viewed from the underside, taper slightly towards each other in the direction of the upper side, such that loose inner box holders 4 are nestable within each other. Moreover, the inner box holder 4 provides a stable basis, so that its falling over is virtually precluded. Provided in the sidewalls 10 of the inner box holder 4 are light passage openings 11. Adjacent an upper edge of the sidewalls 10 of the inner box holder 4, the sidewalls 10 are provided with a double wall 12, 13, which jointly define a recess 14. The recess 14 is so designed that the first projection 8 or the second projection 9 of the inner box 3 is receivable therein. The recess or groove 14 extends throughout the circumference of the inner box holder 4. Adjacent the lower side of the sidewalls 10, the lower edge is defined by two substantially parallel extending inner box holder sidewall parts 15, 16, more particularly an inner wall part 15 and an outer wall part 16. Over a first part A of the circumference of the inner box holder 4, the inner wall part 15 projects further down than the outer wall part 16, while over a second part B of the circumference, the outer wall part 16 projects further down than the inner wall part 15. In the first exemplary embodiment, the lower edge of the inner box holder 4 is provided with two first parts A and two second parts B which are complementary, such that, with two inner box holders 4 placed onto each other by their lower edges, the first circumference parts A of the first inner box holder 4 abut against the second circumference parts B of the second inner box holder 4′. Thus, a stable lateral locking is obtained when two inner box holders 4, 4′ are stacked onto each other by their lower edges, which is shown in FIG. 1 at the top, right.

FIG. 11 shows a flower box assembly of an inner box holder 4 and an inner box 3 placed therein. Clearly visible is that the downwardly directed first projection 8 of the inner box 3 is received in the recess 14 of the inner box holder 4. Onto the assembly shown, a second inner box holder 4′ has been placed, viz. in inverted position. Clearly visible is that the recess 14′ of the second inner box holder 4′ has received the second projection 9 of the inner box 3. All this is represented in more detail in FIG. 11. The second inner box holder 4′ protects the cut flowers projecting above the upper edge of the inner box 3 from damage. Moreover, the second inner box holder 4′ provides a support for a second flower box assembly, to be placed on the second inner box holder 4′, which is shown in FIG. 1 at the top, right.

Summarizing, it may be stated that in the first exemplary embodiment, the inner box holder 4 and the inner box 3 are so designed that onto an assembly of an inner box holder 4 and an inner box 3, a second inner box holder 4′ is placeable in inverted position. The downwardly directed upper side of the second inner box holder 4′ then engages an upper side of the inner box 3. Possibly, in an alternative elaboration of the invention, the second inner box holder 4′ could engage an upper side of the first inner box holder 4. Further, the inner box holder 4 is so designed that onto the second inner box holder 4′ a third inner box holder 4′ is placeable, with the upper side directed upwards, such that, in turn, an inner box 3″ is receivable therein.

The second exemplary embodiment 102 represented in FIGS. 12-15 differs from the first exemplary embodiment in that the circumferential wall 107 of the upper side of the inner box 103 is provided with just one circumferential projection 108, extending in downward direction, which is clearly visible in FIG. 15. In this exemplary embodiment, the circumferential wall 107 tapers towards the circumferential projection 108. Moreover, at its upper side, the inner box holder 104 is only provided with an upper edge 112 extending inwards in horizontal direction. The lower edge of the inner box holder 104 comprises a number of toothed provisions 121 to engage an opposed complementary lower edge of another inner box holder. Two inner box holders 104 are stackable onto each other by their lower edges in a stable manner by the use of these complementary teeth 121. Such toothed provisions 121 can be designed in various ways and in different shapes. Further, the inner box holder 104 is integrally provided with handgrips 122, which are simply provided by horizontal recesses 123 extending near the lower edge of the inner box holder 104.

The inner box 103 of the second exemplary embodiment 102 is, in accordance with the position of the first exemplary embodiment as shown in FIG. 1, detachably placeable in the inner box holder 104 when the inner box holder 104 is in a first position. The first position of the inner box holder 104 of the second exemplary embodiment is represented in FIG. 12. In this position, the circumferential projection 108 of the inner box 103 engages an upper side 112a of the upper edge 112 of the inner box holder 164. The inner box 103 here extends substantially within the inner box holder 104. As is clearly visible in FIGS. 13 and 15, the inner box holder 104 can further be used in an inverted second position to hold the inner box 103. In that case, the circumferential projection 108 of the inner box 104 rests on the upwardly facing underside 112b of the upper edge 112 of the inner box holder, so that the inner box 103 extends substantially under the inner box holder 104. The inner box holder 104 can thus serve, for instance, as an aid for carrying the inner box 103 by hand, to which end the inner box holder 104 can be readily held by the handgrips 122. In addition, the inner box holder 104 in the inverted position shown in FIG. 13 can afford protection to the contents of the inner box 103 extending under it and/or constitute an extension of the sidewalls of the inner box 103. The position of the assembly represented in FIG. 13 can be simply achieved by placing the inner box 103 in the inverted inner box holder 104, and subsequently pulling up the inner box holder 104 alongside the inner box 103 until the circumferential projection 108 of the inner box 103 rests on the underside 112b of the upper edge 112 of the inner box holder 104.

As FIGS. 13-15 show, the inner box 103 of the second exemplary embodiment, in particular at the corners adjacent the upper side, is provided with a number of engagement means, in particular vertical clamping projections 120, to engage the inner box holder 104 in the position of the assembly 102 shown in FIG. 13. Preferably, the engagement means 120 are arranged to retain the inner box holder 104 with an engagement force that is greater than the weight of the inner box holder 104, so that the inner box holder 104 can easily preserve the position shown in FIG. 12. The engagement means mentioned can be designed in different ways and comprise, for instance, clamping means, snap means or the like. In addition, the inner box 103 and/or the inner box holder 104 may for instance be provided with such engagement means.

It will be clear that the invention is not limited to the exemplary embodiment described, but that various modifications are possible within the framework of the invention as defined by the claims.

Thus, the assemblies can be designed in various shapes and dimensions, for instance with different heights. FIG. 16 shows by way of example a front view of a high design 102a and a low design 102b of an assembly of an inner box and an inner box holder according to the invention. In FIG. 16, for clarity, only the inner box holders 104a, 104b of the two assemblies are represented. Preferably, the different assemblies 102a, 102b are combinable with each other. To that end, the different inner box holders 104a, 104b and/or inner boxes may for instance be provided with identical upper sides and identical lower sides. Thus, the inner box holder 104a of one assembly 102a may, for instance by an upper side, in an inverted position, be stackable onto the upper side of the inner box holder 104b of the other assembly 102b, which is indicated in FIG. 15 with arrow W. The same applies as regards placing the inner box holders 104a, 104b onto each other by way of lower sides, which is indicated with arrow V. In addition, an inner box of one assembly 102a may be held, for instance, in or under the inner box holder 104b of the other assembly 102b.

1. A flower box assembly comprising an inner box and an inner box holder, the inner box having a bottom wall and at least one closed sidewall, such that it is at least partly fillable with water, the inner box holder having at least one sidewall and an open lower side and upper side, the inner box being provided with means with the aid of which the inner box is detachably connectible with the inner box holder.

2. A flower box assembly according to claim 1, wherein the inner box holder and the inner box are designed such that onto an assembly of an inner box holder and an inner box, a second inner box holder is placeable in inverted position, the downwardly directed upper side of the second inner box holder engaging an upper side of the inner box, or the upper side of the first inner box holder.

3. A flower box assembly according to claim 2, wherein the inner box holder is designed such that onto the second inner box holder a third inner box holder is placeable with the upper side directed upwards, such that, in turn, an inner box is receivable therein.

4. A flower box assembly according to claim 1, wherein the sidewalls of the inner box holders viewed from the bottom, taper slightly towards each other in the direction of the upper side, such that the inner box holders are nestable within each other.

5. A flower box assembly according to claim 1, wherein the sidewalls of the inner boxes, viewed from an upper side, taper slightly towards each other in the direction of the bottom wall, such that the inner boxes are nestable within each other.

6. A flower box assembly according to claim 1, wherein in the at least one sidewall of the inner box holders, at least one light passage opening is included.

7. A flower box assembly according to claim 1, wherein the means with the aid of which the inner box is connectible with the inner box holder comprise at least one circumferential wall extending at least in horizontal direction, which is connected with the inner box adjacent an upper edge of the at least one sidewall of the inner box, which circumferential wall is provided with at least one first projection which engages an upper edge adjacent the upper side of the inner box holder.

8. A flower box assembly according to claim 7, wherein the projection comprises a wall part extending throughout the circumference of the inner box, from the circumferential wall in downward direction.

9. A flower box assembly according to claim 7, wherein the projection engages a first recess in an upper edge adjacent the upper side of the inner box holder.

10. A flower box assembly according to claim 23, wherein the first recess in the upper edge of the inner box holder also extends throughout the circumference of the inner box holder.

11. A flower box assembly according to claim 9, wherein the circumferential wall is provided with at least one second projection which extends in upward direction from the circumferential wall and which is situated opposite the first projection and whose configuration is such that it is receivable in said first recess of a second inner box holder placed in inverted position onto the assembly of an inner box and an inner box holder.

12. A flower box assembly according to claim 1, wherein the lower edge of the inner box holder is designed such that two inner box holders placed onto each other by their lower edges form a stable stacking.

13. A flower box assembly according to claim 12, wherein the lower edge is defined by two substantially parallel extending inner box holder sidewall parts, more particularly an inner wall part and an outer wall part, while over a first part of the circumference of the inner box holder the inner wall part projects further down than the outer wall part, and over a second part of the circumference the outer wall part projects further down than the inner wall part.

14. A flower box assembly according to claim 13, wherein the first part and the second part of the circumference are complementary, such that, with two inner box holders placed onto each other by the lower edges, the first circumference part of the first inner box holder abuts against the second circumference part of the second inner box holder.

15. A flower box assembly according to claim 12, wherein the lower edge of each inner box holder is provided with at least one toothed provision to stack the inner box holders onto each other by the lower edges in a stable manner.

16. A flower box assembly according to claim 1, wherein the inner box and the inner box holders have a substantially rectangular cross section.

17. A flower box assembly according to claim 1, wherein the inner box is detachably connectible with the inner box holder when the inner box holder is in a first position, and the inner box is also detachably connectible with the inner box holder when the inner box holder is in an inverted, second position.

18. A flower box assembly according to claim 17, wherein the inner box in said first position of the inner box holder extends substantially within the inner box holder, and the inner box in said second position of the inner box holder extends substantially under it.

19. A flower box assembly according to claim 17, wherein the assembly is provided with engagement means which are arranged to couple the inner box holder in said second position to the inner box with a particular engaging force, which engaging force is greater than the weight of the inner box holder.

20. A flower box assembly according to claim 1, provided with at least two different inner box holders and/or inner boxes with different heights, wherein the different inner box holders are preferably provided with identical upper sides and identical lower sides, the different inner boxes being preferably provided with identical upper sides and identical lower sides.

21. A flower box assembly according to claim 2, wherein the sidewalls of the inner box holders viewed from the bottom, taper slightly towards each other in the direction of the upper side, such that the inner box holders are nestable within each other.

22. A flower box assembly according to claim 3, wherein the sidewalls of the inner box holders viewed from the bottom, taper slightly towards each other in the direction of the upper side, such that the inner box holders are nestable within each other.

23. A flower box assembly according to claim 8, wherein the projection engages a first recess in an upper edge adjacent the upper side of the inner box holder.

24. A flower box assembly according to claim 4, wherein:
the sidewalls of the inner boxes, viewed from an upper side, taper slightly towards each other in the direction of the bottom wall, such that the inner boxes are nestable within each other;
in the at least one sidewall of the inner box holders, at least one light passage opening is included;
the means with the aid of which the inner box is connectible with the inner box holder comprise at least one circumferential wall extending at least in horizontal direction, which is connected with the inner box adjacent an upper edge of the at least one sidewall of the inner box, which circumferential wall is provided with at least one first projection which engages an upper edge adjacent the upper side of the inner box holder.

25. A flower box assembly according to claim 7, wherein:
the projection comprises a wall part extending throughout the circumference of the inner box, from the circumferential wall in downward direction;
the projection engages a first recess in an upper edge adjacent the upper side of the inner box holder;
the first recess in the upper edge of the inner box holder also extends throughout the circumference of the inner box holder;
the circumferential wall is provided with at least one second projection which extends in upward direction from the circumferential wall and which is situated opposite the first projection and whose configuration is such that it is receivable in said first recess of a second inner box holder placed in inverted position onto the assembly of an inner box and an inner box holder;
the lower edge of the inner box holder is designed such that two inner box holders placed onto each other by their lower edges form a stable stacking.

26. A flower box assembly according to claim 12, wherein:
the lower edge is defined by two substantially parallel extending inner box holder sidewall parts, more particularly an inner wall part and an outer wall part, while over a first part of the circumference of the inner box holder the inner wall part projects further down than the outer wall part, and over a second part of the circumference the outer wall part projects further down than the inner wall part;
the first part and the second part of the circumference are complementary, such that, with two inner box holders placed onto each other by the lower edges, the first circumference part of the first inner box holder abuts against the second circumference part of the second inner box holder;
the lower edge of each inner box holder is provided with at least one toothed provision to stack the inner box holders onto each other by the lower edges in a stable manner;
the inner box and the inner box holders have a substantially rectangular cross section.

27. A flower box assembly according to claim 16, wherein:
the inner box is detachably connectible with the inner box holder when the inner box holder is in a first position, and the inner box is also detachably connectible with the inner box holder when the inner box holder is in an inverted, second position;
the inner box in said first position of the inner box holder extends substantially within the inner box holder, and the inner box in said second position of the inner box holder extends substantially under it;
the assembly is provided with engagement means which are arranged to couple the inner box holder in said second position to the inner box with a particular engaging force, which engaging force is greater than the weight of the inner box holder;
wherein at least two different inner box holders and/or inner boxes with different heights are provided, and wherein the different inner box holders are preferably provided with identical upper sides and identical lower sides, the different inner boxes being preferably provided with identical upper sides and identical lower sides.
